(19) United States
(12) Patent Application Publication
(10) Pub. No.: US 2026/0139725 A1
(43) Pub. Date: May 21, 2026

(54) VIBRATION ISOLATION DEVICE AND VIBRATION ISOLATION MECHANISM

(71) Applicant: NOK CORPORATION, Tokyo (JP)

(72) Inventor: Shun OKUTANI, Tottori (JP)

(73) Assignee: NOK CORPORATION, Tokyo (JP)

(21) Appl. No.: 19/257,894

(22) Filed: Jul. 2, 2025

(30) Foreign Application Priority Data
Nov. 15, 2024 (JP) 2024-199854

(51) Int. Cl. F16F 15/04

(52) U.S. Cl. CPC F16F 15/04

(57) ABSTRACT

A vibration isolation device disposed between a first member and a second member includes: a first support body fixed to the first member; a second support body fixed to the second member; and a resilient body connecting the first support body with the second support body. The first support body includes: a circular first base portion including a first fixing surface; and a first shaft portion protruding from the first fixing surface along a central axis and inserted into a mounting hole of the first member. The resilient body includes: a first side wall portion covering an outer peripheral surface of the first base portion and having an outer wall surface including a plane in contact with a first rotation-restricting part for restricting rotation of the first support body about the central axis; and a vibration isolator located between the first support body and the second support body.

### CROSS REFERENCE TO RELATED APPLICATION

This Application is based on, and claims priority from, Japanese Patent Application No. 2024-199854, filed Nov. 15, 2024, the entire content of which is incorporated herein by reference.

### BACKGROUND

### Technical Field

The present disclosure relates to techniques for vibration isolation.

### Description of Related Art

A vibration isolator that reduces transmission of vibration between a first member and a second member has been conventionally proposed. For example, Japanese Patent Application Laid-Open Publication No. 2009-168118 (hereafter, JP 2009-168118) discloses a vibration isolator in which a resilient body is fixed to a metal fastening seat member. In this vibration isolator, a plurality of anti-rotation parts is provided on a surface of the fastening seat member away from the resilient body.

However, a metal fastening seat member with many protrusions as described in JP 2009-168118 has a drawback in that manufacturing costs are high.

### SUMMARY

In view of the above circumstances, an object of one aspect of the present disclosure is to reduce the manufacturing cost of vibration isolation devices while maintaining their vibration isolation performance.

In one aspect, a vibration isolation device is disposed between a first member and a second member and includes: a first support body fixed to the first member; a second support body fixed to the second member; and a resilient body that connects the first support body with the second support body, in which the first support body includes: a first base portion having a circular shape and including a first fixing surface; and a first shaft portion protruding from the first fixing surface along a central axis and inserted into a mounting hole of the first member, in which the resilient body includes: a first side wall portion covering an outer peripheral surface of the first base portion; and a vibration isolator located between the first support body and the second support body, in which an outer wall surface of the first side wall portion includes a planar surface portion, with the planar surface portion comprising a plane in contact with a first rotation-restricting part for restricting rotation of the first support body about the central axis.

In another aspect, a vibration isolation mechanism includes: a first member and a second member, and a vibration isolation device disposed between the first member and the second member, in which the vibration isolation device includes: a first support body fixed to the first member; a second support body fixed to the second member; and a resilient body that connects the first support body with the second support body, in which the first support body includes: a first base portion having a circular shape and including a first fixing surface; a first shaft portion protruding from the first fixing surface along a central axis and inserted into a mounting hole of the first member, in which the resilient body includes: a first side wall portion covering an outer peripheral surface of the first base portion; and a vibration isolator located between the first support body and the second support body, and in which an outer wall surface of the first side wall portion includes a planar surface portion, with the planar surface portion comprising a plane in contact with a first rotation-restricting part for restricting rotation of the first support body about the central axis.

### BRIEF DESCRIPTION OF THE DRAWINGS

FIG. 1 is a side view of a vibration isolation mechanism according to a first embodiment.

FIG. 2 is a perspective view of a vibration isolation device.

FIG. 3 is a side view of the vibration isolation device.

FIG. 4 is a cross-sectional view of the vibration isolation device, taken along line IV-IV in FIG. 6.

FIG. 5 is a cross-sectional view of the vibration isolation device, taken along line V-V in FIG. 6.

FIG. 6 is a plan view of the vibration isolation device.

FIG. 7 is a plan view of the vibration isolation device.

FIG. 8 is a side view showing the vibration isolation device in the installed state.

FIG. 9 is a perspective view of a vibration isolation device according to a second embodiment.

### DESCRIPTION OF THE EMBODIMENTS

Embodiments of the present disclosure will be described with reference to the drawings. In the drawings, the dimensions and scales of each element may differ from actual products. Also, the embodiments described below are exemplary forms envisioned when implementing the present disclosure. Therefore, the scope of the present disclosure is not limited to the following embodiments.

### A: First Embodiment

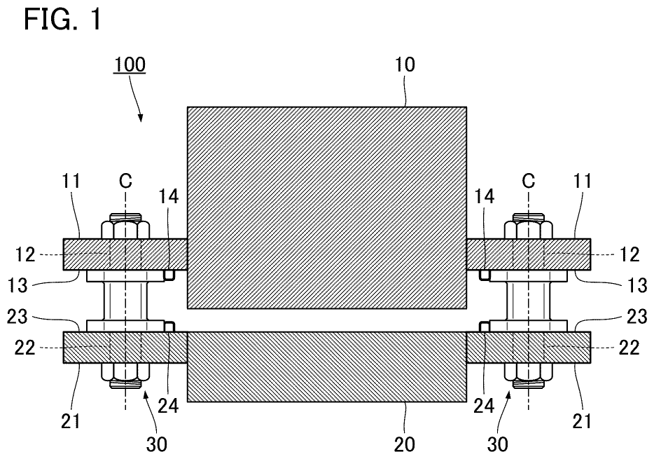

FIG. 1 is a side view of a vibration isolation mechanism 100 according to a first embodiment. As illustrated in FIG. 1, the vibration isolation mechanism 100 of the first embodiment includes a first structure 10, a second structure 20, and a plurality of vibration isolation devices 30. Each of the plurality of vibration isolation devices 30 is a device that suppresses the transmission of (i.e., isolates) vibration between the first structure 10 and the second structure 20. Each of the plurality of vibration isolation devices 30 has the same configuration.

The first structure 10 is a structure that generates vibration. Specifically, the first structure 10 comprises one of a variety of mechanical devices mounted on a moving body such as an electric vehicle. For example, a housing of an electric motor or auxiliary equipment (e.g., a cooling compressor or pump, etc.) is illustrated as the first structure 10. The first structure 10 includes a plurality of first members 11 disposed at different positions. Each of the first members 11 is a bracket for mounting the vibration isolation device 30. In each of the first members 11, a first mounting hole 12 for mounting the vibration isolation device 30 is formed. The first mounting hole 12 is a circular through hole.

The second structure 20 is a foundation that supports the first structure 10. For example, a vehicle body frame mounted on a moving body, such as an electric vehicle, is exemplified as the second structure 20. The second structure 20 includes a plurality of second members 21 disposed at different positions. Each of the second members 21 is a bracket for mounting the vibration isolation device 30. In each of the second members 21, a second mounting hole 22 for mounting the vibration isolation device 30 is formed. The second mounting hole 22 is a circular through hole.

A first member 11 and a second member 21 face each other and make up a pair. A vibration isolation device 30 is disposed for each pair of the first member 11 and the second member 21. Specifically, the vibration isolation device 30 is disposed between the first member 11 and the second member 21. The vibration isolation device 30 suppresses the transmission of vibration between the first member 11 and the second member 21. In the above description, the first structure 10 is a vibration source. However, the second structure 20 may instead be a vibration source, or both the first structure 10 and the second structure 20 may be vibration sources. Each of the plurality of vibration isolation devices 30 is also used as an element that supports the first structure 10. More than one vibration isolation device 30 may be disposed between the first member 11 and the second member 21.

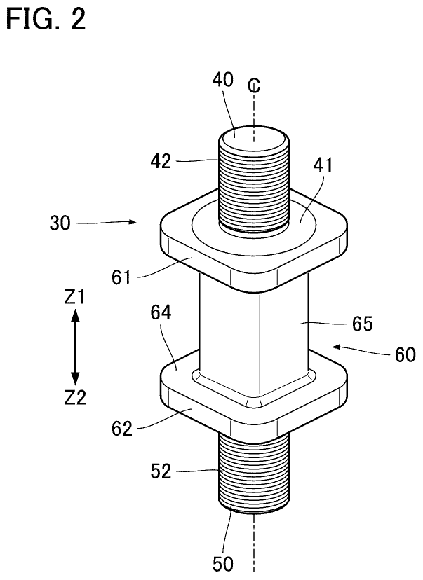

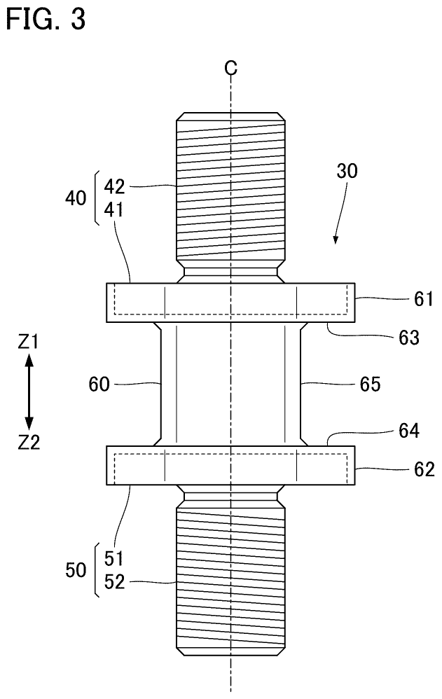

FIG. 2 is a perspective view of the vibration isolation device 30, and FIG. 3 is a side view of the vibration isolation device 30. FIGS. 2 and 3 show the central axis C of the vibration isolation device 30. In the following description, the direction of the central axis C is referred to as an “axial direction”. The axial direction comprises a Z1 direction and a Z2 direction. The Z1 direction is one direction along the central axis C, and the Z2 direction is a direction opposite to the Z1 direction. Furthermore, a direction along a circumference of a virtual circle having any diameter centered on the central axis Cis referred to as a “circumferential direction”, and a direction of a radius of the virtual circle is referred to as a “radial direction”. A radial direction toward the central axis Cis referred to as “radially inward”, and a radial direction away from the central axis C is referred to as “radially outward”.

As illustrated in FIGS. 2 and 3, the vibration isolation device 30 includes a first support body 40, a second support body 50, and a resilient body 60. The first support body 40 and the second support body 50 are spaced apart from each other in the axial direction. The first support body 40 is fixed to the first member 11. The second support body 50 is fixed to the second member 21. The resilient body 60 connects the first support body 40 with the second support body 50. The first support body 40 and the second support body 50 are also referred to as structures that support the resilient body 60.

The first support body 40 and the second support body 50 are structures having higher rigidity than the resilient body 60, and are formed of, for example, a metal material. Various manufacturing techniques such as forging or casting are used to manufacture the first support body 40 and the second support body 50. Examples of the metal material used for the first support body 40 and the second support body 50 include, but are not limited to stainless steel, an SPCC (Steel Plate Cold Commercial), and an SPHC (Steel Plate Hot Commercial). The first support body 40 and the second support body 50 may be made of, for example, a highly rigid resin material. The first support body 40 and the second support body 50 may be formed of the same type of material or may be formed of different types of materials.

The resilient body 60 is a vibration absorbing member that absorbs vibration generated in the first structure 10. The resilient body 60 is formed of a resilient material such as a rubber material. Examples of rubber materials used for the resilient body 60 include, but are not limited to chloroprene rubber (CR), silicone rubber (SR), acrylic rubber (ACM), urethane rubber (U), polyurethane rubber (PUR), vinyl methyl silicone rubber (VMQ), ethylene propylene diene rubber (EPDM), and fluororubber (FKM). The resilient body 60 may be formed of, for example, a resin material having low rigidity.

The first support body 40, the second support body 50, and the resilient body 60 are integrally molded by injection molding (i.e., insert molding) using a molding mold such as a metal mold or a resin mold. Specifically, the vibration isolation device 30 is manufactured by injecting a molten resin, which serves as the material of the resilient body 60, into a molding mold in which the first support body 40 and the second support body 50 have been placed, and then releasing the molded product after the molten resin has cured. That is, the vibration isolation device 30 is a molded article in which the first support body 40, the second support body 50, and the resilient body 60 are integrally formed.

In the above-described configuration, the vibration transmitted from the first structure 10 to the first support body 40 is absorbed by the resilient deformation of the resilient body 60. Similarly, the vibration transmitted from the second structure 20 to the second support body 50 is absorbed by the resilient deformation of the resilient body 60. That is, the vibration isolation device 30 suppresses the transmission of vibration between the first structure 10 and the second structure 20.

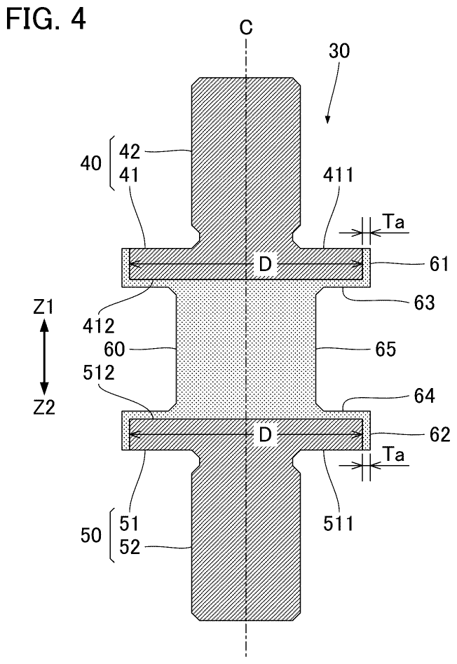

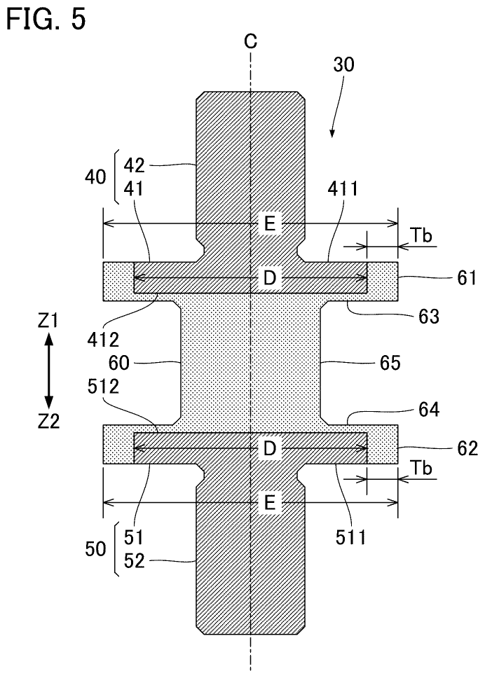

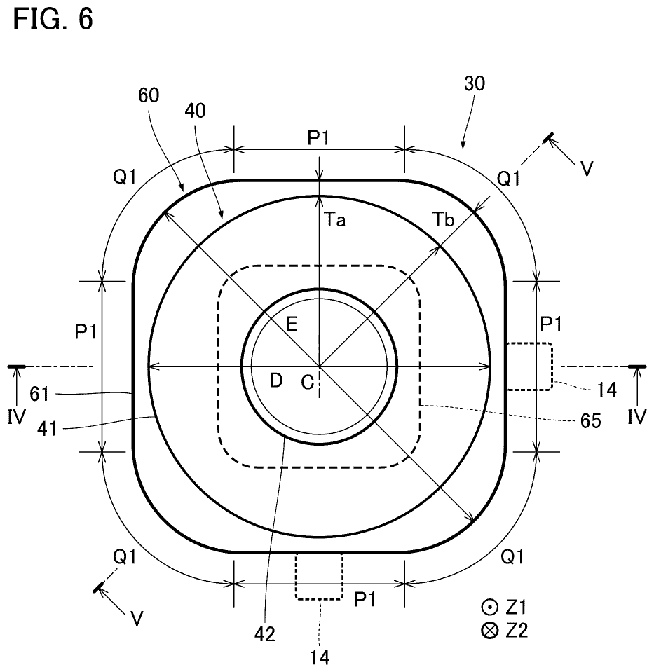

FIGS. 4 and 5 are cross-sectional views of the vibration isolation device 30. Cross sections including the central axis C are shown in FIGS. 4 and 5. FIG. 6 is a plan view of the vibration isolation device 30 as viewed from a viewpoint in the Z1 direction relative to the vibration isolation device 30. A cross-sectional view taken along line IV-IV in FIG. 6 corresponds to FIG. 4, and a cross-sectional view taken along line V-V in FIG. 6 corresponds to FIG. 5.

As illustrated in FIGS. 4 to 6, the first support body 40 is a structure including a first base portion 41 and a first shaft portion 42. The first base portion 41 and the first shaft portion 42 are integrally formed. However, the first shaft portion 42 may be formed separately from the first base portion 41 and fixed to the first base portion 41.

The first base portion 41 is a portion formed in a circular shape having an outer diameter D as viewed in the axial direction. The first base portion 41 is disposed coaxially with the central axis C. Specifically, the first base portion 41 is a circular plate-shaped portion including a first fixing surface 411 and a first facing surface 412 located on opposite sides to each other. The first fixing surface 411 is a circular planar surface facing the Z1 direction, and the first facing surface 412 is a circular planar surface facing the Z2 direction. The first fixing surface 411 and the first facing surface 412 are perpendicular to the axial direction. The plate thickness of the first base portion 41 is constant over the entire area of the first base portion 41.

The first shaft portion 42 is a columnar part that protrudes in the Z1 direction from the first fixing surface 411 along the central axis C. The first shaft portion 42 is disposed coaxially with the first base portion 41. The outer diameter of the first shaft portion 42 is smaller than the outer diameter D of the first base portion 41. Therefore, as illustrated in FIG. 6, the outer peripheral surface of the first shaft portion 42 is located radially inward of the outer peripheral surface of the first base portion 41 as viewed in the axial direction. As illustrated in FIGS. 2 and 3, a spiral screw groove around the central axis C is formed on the outer peripheral surface of the first shaft portion 42.

As described above, the first support body 40 is a rotating body around the central axis C. Therefore, compared with a configuration in which the planar shape of the first base portion 41 is, for example, a polygonal shape (that is, a configuration in which the first support body 40 is a non-rotating member), the manufacturing cost of the first support body 40 is easily reduced. For example, the first support body 40 can be manufactured by inexpensive rotation processing using a processing device such as a lathe.

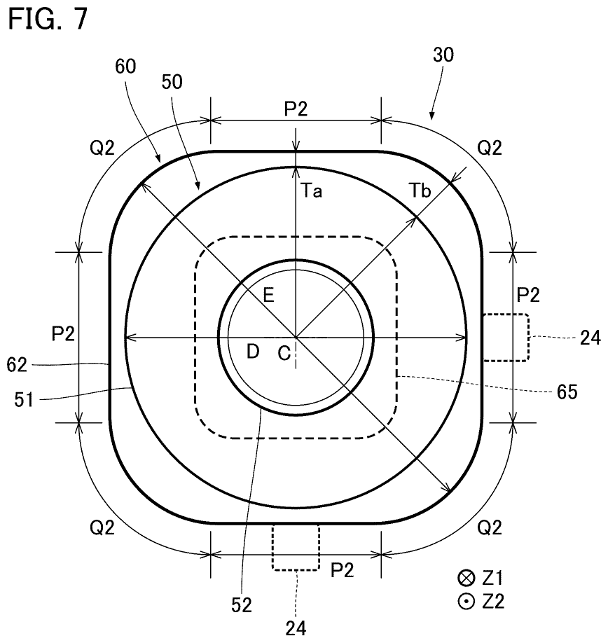

FIG. 7 is a plan view of the vibration isolation device 30 as viewed from a viewpoint in the Z2 direction relative to the vibration isolation device 30. As illustrated in FIGS. 4 to 7, the shape of the second support body 50 and the shape of the first support body 40 are the same. Specifically, as illustrated in FIGS. 4 and 5, the second support body 50 is a structure including a second base portion 51 and a second shaft portion 52. The second base portion 51 and the second shaft portion 52 are integrally formed. However, the second shaft portion 52 may be formed separately from the second base portion 51 and fixed to the second base portion 51.

The second base portion 51 is a portion formed in a circular shape having an outer diameter D as viewed in the axial direction. The second base portion 51 is disposed coaxially with the central axis C. Specifically, the second base portion 51 is a circular plate-shaped portion including the second fixing surface 511 and the second facing surface 512 located on opposite sides to each other. The second fixing surface 511 is a circular planar surface facing the Z2 direction, and the second facing surface 512 is a circular planar surface facing the Z1 direction. The second fixing surface 511 and the second facing surface 512 are perpendicular to the axial direction. The thickness of the second base portion 51 is constant over the entire area of the second base portion 51. As illustrated in FIGS. 4 and 5, the first facing surface 412 of the first support body 40 and the second facing surface 512 of the second support body 50 are axially spaced apart from each other.

The second shaft portion 52 is a columnar portion protruding in the Z2 direction from the second fixing surface 511 along the central axis C. The second shaft portion 52 is disposed coaxially with the second base portion 51. The outer diameter of the second shaft portion 52 is smaller than the outer diameter D of the second base portion 51.

Therefore, as illustrated in FIG. 7, the outer peripheral surface of the second shaft portion 52 is located radially inward of the outer peripheral surface of the second base portion 51 as viewed in the axial direction. As illustrated in FIGS. 2 and 3, a spiral screw groove around the central axis C is formed on the outer peripheral surface of the second shaft portion 52.

As described above, the second support body 50 is a rotating body around the central axis C. Therefore, compared with a configuration in which the planar shape of the second base portion 51 is, for example, a polygonal shape (that is, a configuration in which the second support body 50 is a non-rotating body), the manufacturing cost of the second support body 50 is easily reduced. For example, the second support body 50 can be manufactured by inexpensive rotation processing using a processing device such as a lathe.

As illustrated in FIG. 4, the resilient body 60 is a structure in which a first side wall portion 61, a second side wall portion 62, a first covering part 63, a second covering part 64, and a vibration isolator 65 are integrally formed. The first sidewall portion 61 and the first covering part 63 are located at a Z1-direction end portion of the resilient body 60, and the second sidewall portion 62 and the second covering part 64 are located at a Z2-direction end portion of the resilient body 60. The boundaries of mutually adjacent portions among the plurality of portions constituting the resilient body 60 are formed in arc shapes (R-shapes).

The vibration isolator 65 is located between the first support body 40 and the second support body 50. More specifically, the vibration isolator 65 is located between the first facing surface 412 and the second facing surface 512. The vibration isolator 65 is a columnar portion elongated in the axial direction, and is disposed coaxially with the central axis C. The vibration isolator 65 of the first embodiment is a quadrangular prism-shaped portion having corner portions formed in arc shapes (R-shapes). That is, the shape of a cross section (hereafter, a “transverse cross section”) perpendicular to the central axis C is a square in which each corner portion is formed in an arc shape (R shape).

An external dimension E in the transverse cross section of the vibration isolator 65 is constant along the central axis C. The external dimension E is defined as a diameter of a circumscribed circle of the transverse cross section of the vibration isolator 65. Accordingly, the external dimension E is also expressed as the maximum dimension in the transverse cross section of the vibration isolator 65. The external dimension E of the vibration isolator 65 is greater than the outer diameter D of the first base portion 41 and the second base portion 51. As described above, in the first embodiment, since the external dimension E of the vibration isolator 65 is constant along the central axis C, an advantage is obtained in that the external shape of the vibration isolator 65 can be simplified.

As illustrated in FIGS. 4 and 5, the first side wall portion 61 is a portion covering the outer peripheral surface of the first base portion 41. Specifically, the first side wall portion 61 is an annular or tubular portion that covers the entire circumference of the outer peripheral surface of the first base portion 41. As described above, since the first base portion 41 of the first support body 40 has a circular shape, the shape of the inner wall surface of the first side wall portion 61 as viewed in the axial direction is a circular shape having the same diameter as the first base portion 41. A Z1-direction surface (an end surface facing the Z1 direction) of the first side wall portion 61 is located in the same plane as the first fixing surface 411 of the first base portion 41.

As illustrated in FIG. 6, the external shape of the first side wall portion 61 as viewed in the axial direction is non-circular. The external shape of the first side wall portion 61 in the first embodiment has a square shape in which the respective corner portions are formed in arc shapes. Specifically, the outer wall surface of the first side wall portion 61 is constituted of a curved surface in which planar surface portions Pl and curved surface portions Q1 are alternately arranged along the circumferential direction. That is, a planar surface portion P1 and a curved surface portion Q1 constituting the outer wall surface of the first side wall portion 61 are adjacent to each other. The planar surface portion P1 is a plane parallel to the central axis C. On the other hand, the curved surface portion Q1 comprises a curved surface. Specifically, the curved surface portion Q1 comprises an arcuate surface (cylindrical surface) centered on an axis parallel to the central axis C. The radius of curvature of the curved surface portion Q1 is less than the radius of curvature of the first base portion 41.

As described above, the first base portion 41 of the first support body 40 has a circular shape, whereas the outer wall surface of the first side wall portion 61 covering the outer peripheral surface of the first base portion 41 has a polygonal shape including the planar surface portions P1 and the curved surface portions Q1. Therefore, as illustrated in FIG. 6, the thickness Ta of the first side wall portion 61 in the planar surface portions P1 is less than the thickness Tb of the first side wall portion 61 in the curved surface portions Q1 (Ta<Tb). The thickness Ta is a distance between the inner wall surface and the outer wall surface (i.e., the planar surface portions P1) of the first side wall portion 61, along a straight line perpendicular to the planar surface portion P1 and passing through the central axis C. The thickness Tb is a distance between the inner wall surface and the outer wall surface (i.e., the curved surface portions Q1) of the first side wall portion 61, along a straight line passing through the curved surface portion Q1 and the central axis C. The thickness Tb is also expressed as the greatest thickness of the first side wall portion 61. The ratio Tb/Ta of the thickness Tb in the curved surface portions Q1 to the thickness Ta at the planar surface portions P1 is, for example, 2 or more and 5 or less, and is more preferably 3 or more and 4.5 or less. However, the numerical ranges described above are exemplary, and specific numerical values of the specific Tb/Ta may be freely selected.

In FIG. 6, the outer wall surface of the vibration isolator 65 is indicated by a broken line. As illustrated in FIG. 6, the outer wall surface of the vibration isolator 65 is located radially inward the outer peripheral surface of the first base portion 41 as viewed in the axial direction. Furthermore, the outer wall surface of the vibration isolator 65 is located radially outward of the outer peripheral surface of the first shaft portion 42 as viewed in the axial direction. That is, the outer wall surface of the vibration isolator 65 is located in an annular region between the outer peripheral surface of the first base portion 41 and the outer peripheral surface of the first shaft portion 42 as viewed in the axial direction.

As illustrated in FIGS. 4 and 5, the first covering part 63 is an annular portion that covers a region along the outer peripheral edge of the first facing surface 412 of the first base portion 41. The first covering part 63 connects the first side wall portion 61 with the vibration isolator 65. Specifically, the first covering part 63 connects a Z2-direction end portion of the first side wall portion 61 with a Z1-direction end portion of the vibration isolator 65. That is, the outer peripheral edge of the first covering part 63 is connected to the Z2-direction end portion of the first side wall portion 61, and the inner peripheral edge of the first covering part 63 is connected to the Z1-direction end of the vibration isolator 65. The first covering part 63 comprises a step between the outer wall surface of the first side wall portion 61 and the outer wall surface of the vibration isolator 65.

As illustrated in FIGS. 4 and 5, the second side wall portion 62 is a portion that covers the outer peripheral surface of the second base portion 51. Specifically, the second side wall portion 62 is an annular or tubular portion that covers the entire circumference of the outer peripheral surface of the second base portion 51. As described above, since the second base portion 51 of the second support body 50 has a circular shape, the shape of the inner wall surface of the second side wall portion 62 as viewed in the axial direction is a circular shape having the same diameter as that of the second base portion 51. A Z2-direction surface (an end surface facing the Z2 direction) of the second side wall portion 62 is located in the same plane as the second fixing surface 511 of the second base portion 51.

As illustrated in FIG. 7, the external shape of the second side wall portion 62 as viewed in the axial direction is non-circular. The external shape of the second side wall portion 62 in the first embodiment has a square shape in which the respective corner portions are formed in arc shapes. Specifically, the outer wall surface of the second side wall portion 62 is constituted of a curved surface in which planar surface portions P2 and curved surface portions Q2 are alternately arranged along the circumferential direction.

That is, a planar surface portion P2 and a curved surface portion Q2 constituting the outer wall surface of the second side wall portion 62 are adjacent to each other. The planar surface portion P2 is a plane parallel to the central axis C. On the other hand, the curved surface portion Q2 is constituted by a curved surface. Specifically, the curved surface portion Q2 comprises an arcuate surface (cylindrical surface) centered on an axis parallel to the central axis C. The radius of curvature of the curved surface portion Q2 is less than the radius of curvature of the second base portion 51.

As described above, the second base portion 51 of the second support body 50 has a circular shape, whereas the outer wall surface of the second side wall portion 62 covering the outer peripheral surface of the second base portion 51 has a polygonal shape including the planar surface portions P2 and the curved surface portions Q2. Therefore, as illustrated in FIG. 7, the thickness Ta of the second side wall portion 62 in the planar surface portions P2 is less than the thickness Tb of the second side wall portion 62 in the curved surface portions Q2 (Ta<Tb). The ratio Tb/Ta of the thickness Tb to the thickness Ta is, as described above, for example, 2 or more and 5 or less, and is more preferably 3 or more and 4.5 or less. The thickness Tb is also expressed as the largest thickness of the second side wall portion 62.

In FIG. 7, the outer wall surface of the vibration isolator 65 is indicated by a broken line. As illustrated in FIG. 7, the outer wall surface of the vibration isolator 65 is located radially inward the outer peripheral surface of the second base portion 51 as viewed in the axial direction. Furthermore, the outer wall surface of the vibration isolator 65 is located radially outward of the outer peripheral surface of the second shaft portion 52 as viewed in the axial direction. That is, the outer wall surface of the vibration isolator 65 is located in an annular region between the outer peripheral surface of the second base portion 51 and the outer peripheral surface of the second shaft portion 52 as viewed in the axial direction.

As illustrated in FIGS. 4 and 5, the second covering part 64 is an annular portion covering a region along the outer peripheral edge of the second facing surface 512 of the second base portion 51. The second covering part 64 connects the second side wall portion 62 with the vibration isolator 65. Specifically, the second covering part 64 connects a Z1-direction end portion of the second side wall portion 62 with a Z2-direction end portion of the vibration isolator 65. That is, the outer peripheral edge of the second covering part 64 is connected to the Z1-direction edge of the second side wall portion 62, and the inner peripheral edge of the second covering part 64 is connected to the Z2-direction end portion of the vibration isolator 65. The second covering part 64 comprises a step between the outer wall surface of the second side wall portion 62 and the outer wall surface of the vibration isolator 65.

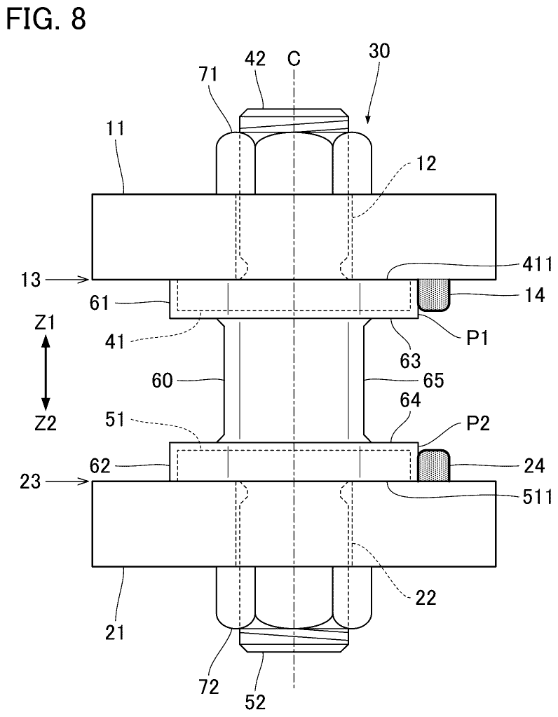

FIG. 8 is a side view showing the vibration isolation device 30 in a state in which it is installed between the first member 11 and the second member 21. As illustrated in FIG. 8, the first member 11 includes a first installation surface 13. The first installation surface 13 is a plane facing the Z2 direction. Similarly, the second member 21 includes a second installation surface 23. The second installation surface 23 is a plane facing the Z1 direction. That is, the first installation surface 13 and the second installation surface 23 face each other with a distance therebetween in the axial direction. The vibration isolation device 30 is disposed between the first installation surface 13 and the second installation surface 23.

The first shaft portion 42 of the first support body 40 is inserted into the first mounting hole 12 of the first member 11. That is, the first support body 40 is fixed to the first member 11, with the first shaft portion 42 inserted in the first mounting hole 12. A fastener 71 is used to fix the first support body 40 to the first member 11. The fastener 71 is, for example, a nut. Specifically, the first support body 40 is fastened to the first member 11 by the engagement of the screw groove formed on the outer peripheral surface of the first shaft portion 42 and the screw groove formed on the inner peripheral surface of the fastener 71. In a state in which the first support body 40 is fixed to the first member 11, the first fixing surface 411 of the first base portion 41 and the surface of the first side wall portion 61 are in close contact with the first installation surface 13 of the first member 11.

As illustrated in FIGS. 6 and 8, a plurality of first protrusions 14 is formed on the first installation surface 13 of the first member 11. The plurality of first protrusions 14 is in contact with the planar surface portions P1 of the first side wall portion 61 of the first support body 40. Specifically, a different first protrusion 14 is in contact with each of the respective planar surface portions P1 of the first side wall portion 61 that are perpendicular to each other. The number and position of the first protrusions 14 may be freely changed.

In the course of rotating the fastener 71 for fixing the first support body 40 to the first member 11, a torque in the circumferential direction acts on the first support body 40. In the first embodiment, rotation of the first support body 40 is restricted, by the first protrusions 14 coming into contact with the planar surface portions P1 of the first side wall portion 61. Therefore, the probability that the vibration isolator 65 of the resilient body 60 will be twisted due to the rotation of the first support body 40 can be reduced. That is, a reduction in the vibration isolation performance caused by the torsion of the vibration isolator 65 can be suppressed. As is apparent from the above description, the first protrusion 14 is an element (first rotation-restricting part) for restricting the rotation of the first support body 40 about the central axis C.

The second shaft portion 52 of the second support body 50 is inserted into the second mounting hole 22 of the second member 21. That is, the second support body 50 is fixed to the second member 21, with the second shaft portion 52 is inserted in the second mounting hole 22. A fastener 72 is used to fix the second support body 50 to the second member 21. The fastener 72 is, for example, a nut. Specifically, the second support body 50 is fastened to the second member 21 by the engagement of the screw groove formed on the outer peripheral surface of the second shaft portion 52 and the screw groove formed on the inner peripheral surface of the fastener 72. In a state in which the second support body 50 is fixed to the second member 21, the second fixing surface 511 of the second base portion 51 and the surface of the second side wall portion 62 are in close contact with the second installation surface 23 of the second member 21.

As illustrated in FIGS. 7 and 8, a plurality of second protrusions 24 is formed on the second installation surface 23 of the second member 21. The plurality of second protrusions 24 is in contact with the planar surface portion P2 of the second side wall portion 62 of the second support body 50. Specifically, a different second protrusion 24 is in contact with each of the respective planar surface portions P2 of the second side wall portion 62 that are perpendicular to each other. The number and position of the second protrusions 24 may be freely changed.

In the course of rotating the fastener 72 for fixing the second support body 50 to the second member 21, a torque in the circumferential direction acts on the second support body 50. In the first embodiment, rotation of the second support body 50 is restricted, by the second protrusion 24 coming into contact with the planar surface portions P2 of the second side wall portion 62. Therefore, the probability that the vibration isolator 65 of the resilient body 60 will be twisted due to the rotation of the second support body 50 can be reduced. That is, a reduction in the vibration isolation performance caused by the torsion of the vibration isolator 65 can be suppressed. As is apparent from the above description, the second protrusion 24 is an element (second rotation-restricting part) for restricting the rotation of the second support body 50 about the central axis C.

As described above, the first side wall portion 61 functions as an element that restricts rotation of the first support body 40 by contact with the first protrusions 14. Similarly, the second side wall portion 62 functions as an element that restricts rotation of the second support body 50 by contact with the second protrusions 24. The vibration isolator 65 functions as an element that absorbs vibration between the first support body 40 and the second support body 50. That is, in the first embodiment, the function of restricting rotation (the first side wall portion 61 and the second side wall portion 62) and the function of absorbing vibration (the vibration isolator 65) are realized by different parts of the resilient body 60.

As described above, in the first embodiment, since the thickness Ta of the first sidewall portion 61 in the planar surface portions P1 is less than the thickness Tb of the first sidewall portion 61 in the curved surface portions Q1, the rigidity of the planar surface portions P1 of the first sidewall portion 61 exceeds the rigidity of the curved surface portions Q1 of the first sidewall portion 61. Therefore, by the first protrusions 14 contacting the planar surface portions P1 of the first side wall portion 61, the rotation of the first support body 40 can be effectively restricted, as compared with a configuration in which the thickness Ta of the first side wall portion 61 in the planar surface portions P1 exceeds the thickness Tb of the first side wall portion 61 in the curved surface portions Q1. The same applies to the second support body 50.

In the first embodiment, as described above, the outer wall surface of the vibration isolator 65 is located radially inward of the outer peripheral surface of the first base portion 41 as viewed in the axial direction. According to the above-described configuration, the vibration of the first support body 40 or the second support body 50 effectively propagates to the resilient body 60, as compared with a configuration in which the outer wall surface of the vibration isolator 65 is located radially outward of the outer peripheral surface of the first base portion 41. Therefore, the transmission of vibration between the first structure 10 and the second structure 20 can be effectively suppressed. Furthermore, compared with a configuration in which the outer wall surface of the vibration isolator 65 is located radially outward of the outer peripheral surface of the first base portion 41, an advantage is also obtained in that the amount of material used to form the resilient body 60 can be reduced. Although the above description focuses on the first support body 40, the same effects can also be achieved with respect to the second support body 50.

In the first embodiment, the outer wall surface of the vibration isolator 65 is located radially outward of the outer peripheral surface of the first shaft portion 42 as viewed in the axial direction. According to the above configuration, the vibration of the first structure 10 or the second structure 20 can be effectively absorbed by the resilient body 60 as compared with a configuration in which the outer wall surface of the vibration isolator 65 is located radially inward of the outer peripheral surface of the first shaft portion 42. Therefore, the transmission of vibration between the first structure 10 and the second structure 20 can be effectively suppressed. Although the above description focuses on the first support body 40, the same effects can also be achieved for the second support body 50.

### B: Second Embodiment

A second embodiment will now be described. It is to be noted that, in each of the second embodiment illustrated below, elements of which the functions are the same as those of the first embodiment will be described with the same reference numerals as those of the first embodiment, and detailed descriptions thereof will be omitted as appropriate.

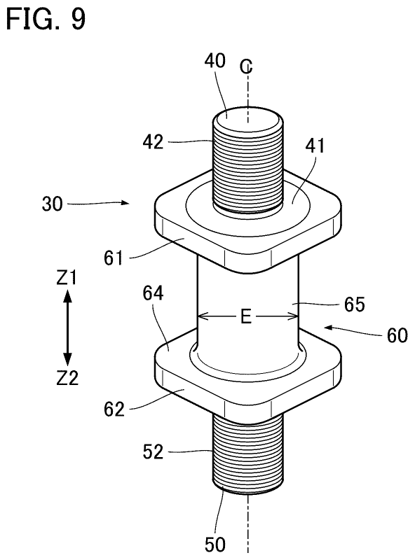

FIG. 9 is a perspective view of the vibration isolation device 30 according to the second embodiment. As illustrated in FIG. 9, the vibration isolator 65 of the resilient body 60 in the second embodiment comprises a columnar portion. That is, the external dimension E in the transverse cross section of the vibration isolator 65 is defined as the diameter of the vibration isolator 65. The external dimension E of the vibration isolator 65 is constant along the central axis C. As in the first embodiment, the outer wall surface of the vibration isolator 65 is located radially inward of the outer peripheral surface of the first base portion 41 as viewed in the axial direction, and is located radially outward of the outer peripheral surface of the first shaft portion 42 as viewed in the axial direction.

Also in the second embodiment, the same effects as those of the first embodiment are attainable. As will be understood from the examples of the first embodiment and the second embodiment, since the resilient body 60 includes the first side wall portion 61, the second side wall portion 62, and the vibration isolator 65, the shape (particularly the cross-sectional shape) of the vibration isolator 65 can be selected independently of the external shapes of the first side wall portion 61 and the second side wall portion 62. The resilient body in the configuration of JP 2009-168118 is limited to a shape (a so-called drum shape). In this shape, the diameter continuously varies depending on the position along the axial direction, and the central portion along the axial direction has a smaller diameter than the diameters of both end portions. In contrast to the configuration of JP 2009-168118, according to the present disclosure, it is possible to improve the degree of freedom in shape (for example, the cross-sectional shape or the size, etc. ,) of the vibration isolator 65 as exemplified in the first embodiment and the second embodiment. For example, the shape of the vibration isolator 65 is selected such that the second moment of area necessary for absorbing the vibration is secured depending on the characteristics of the vibration assumed in the first structure 10 or the second structure 20. The vibration isolator 65 of the resilient body 60 may have a shape in which the diameter of the central portion along the axial direction is less than the diameters of both end portions.

### C: Modifications

Examples of modifications that can be made to the embodiment described above will now be described. Two or more aspects freely selected from the following examples may be appropriately combined as long as they do not conflict with each other.

(1) In each of the above-described embodiments, the external shape of the first side wall portion 61 is a square shape including arcuate corner portions, but the external shape of the first side wall portion 61 may be freely changed. For example, the total number of the corners of the polygon constituting the first side wall portion 61 is freely changed. Furthermore, the external shape of the first side wall portion 61 may be, for example, a shape elongated in a specific direction as viewed in the axial direction (for example, an oval shape). However, from the viewpoint of restricting the rotation of the first support body 40 through contact with the first protrusions 14, it is preferable that the outer wall surface of the first side wall portion 61 include the planar surface portion P1. Although the above description focuses on the first support body 40, the same modification may be applied to the second support body 50.

(2) In each of the above-described embodiments, the first protrusions 14 of the first member 11 are in contact with the planar surface portions P1 of the first side wall portion 61 of the resilient body 60. However, a structure other than the first protrusions 14 may instead serve to restrict the rotation of the first support body 40 through contact with the planar surface portions P1 of the first side wall portion 61. For example, in the course of rotating the fastener 71 to fix the first support body 40 to the first member 11, the planar surface portions P1 of the first side wall portion 61 may be brought into contact with a jig, which is separate from the vibration isolation mechanism 100, such that the first support body 40 is restricted through the contact with the jig. In other words, the first protrusions 14 may be omitted. The first protrusions 14 in the first embodiment and the jig contacting the planar surface portion P1 of the first side wall portion 61 in this modification are comprehensively expressed as an element (first rotation-restricting part) for restricting the rotation of the first support body 40 about the central axis C.

Although the above description focuses on the first support body 40, the same modification may be applied to the second support body 50. For example, in the course of rotating the fastener 72 to fix the second support body 50 to the second member 21, the planar surface portions P2 of the second side wall portion 62 may be brought into contact with a jig, which is separate from the vibration isolation mechanism 100, such that the second support body 50 is restricted through the contact with the jig. In other words, the second protrusions 24 may be omitted. The second protrusions 24 in the first embodiment and the jig contacting the planar surface portions P2 of the second side wall portion 62 in this modification are comprehensively expressed as an element (second rotation-restricting part) for restricting the rotation of the second support body 50 about the central axis C.

(3) The notation “n” (n is a natural number) in the present application is used only as a formal and convenient label for distinguishing each element by notation, and has no substantive meaning. Therefore, it does not restrict the interpretation of the position of each element, the order of manufacture, or the like on the basis of the notation “n”.

### D: Appendix

The following aspects are derivable from the embodiments described above.

A resilient device according to one aspect of the present disclosure is a vibrator device disposed between the first member and the second member, and includes: a first support body fixed to the first member; a second support body fixed to the second member; and a resilient body that connects the first support body with the second support body, in which the first support body includes: a first base portion having a circular shape and including a first fixing surface; and a first shaft portion protruding from the first fixing surface along a central axis and inserted into a mounting hole of the first member, in which the resilient body includes: a first side wall portion covering an outer peripheral surface of the first base portion, and in which a vibration isolator located between the first support body and the second support body, an outer wall surface of the first side wall portion includes a planar surface portion, with the planar surface portion comprising a plane in contact with a first rotation-restricting part for restricting rotation of the first support body about the central axis. In the above aspect, since the first base portion of the first support body has a circular shape, it is easier to reduce the manufacturing cost of the first support body, as compared with a configuration in which the planar shape of the first base member is, for example, a polygonal shape. On the other hand, the first side wall portion covering the outer peripheral surface of the first base portion of the resilient body includes a planar surface portion which is a planar surface abutting against the first rotation-restricting part. Rotation of the first support body is restricted by contact of the first rotation-restricting part with the planar surface portion of the first side wall portion. Therefore, in the course of fixing the first support body to the first member in a state in which the first shaft portion is inserted in the attachment hole of the first member, the probability that the vibration isolator of the resilient body will be twisted due to the rotation of the first support body can be reduced. That is, a reduction in the vibration isolation performance caused by the torsion of the vibration isolator can be suppressed.

In an example (aspect 2) of aspect 1, the outer wall surface of the first side wall portion further includes a curved surface portion, wherein the curved surface portion comprises a curved surface circumferentially adjacent to the planar surface portion, a thickness of the first side wall portion in the planar surface portion is less than a thickness of the first side wall portion in the curved surface portion. In the above aspect, since the thickness of the first side wall portion in the planar surface portion is less than the thickness of the first side wall portion in the curved surface portion, the rigidity of the planar surface portion in the first side wall portion is greater than the rigidity of the curved surface portion in the first side wall portion. Therefore, as compared with a configuration in which the thickness of the first side wall portion in the planar surface portion exceeds the thickness of the first side wall portion in the curved surface portion, the rotation of the first support body can be effectively restricted by the first rotation-restricting part contacting the planar surface portion of the first side wall portion.

In an example (aspect 3) of aspect 1 or aspect 2, an external shape of the first side wall portion as viewed in the direction of the central axis is a polygonal shape with arc-shaped corner portions. According to the above aspect, the external shape of the first side wall portion can be simplified.

In an example (aspect 4) of any one of aspects 1 to 3, an external dimension of the vibration isolator in a cross section perpendicular to the central axis is constant along the central axis. According to the above aspect, the external shape of the vibration isolator can be simplified.

In an example (aspect 5) of any one of aspects 1 to 4, an outer wall surface of the vibration isolator is located radially inward of an outer peripheral surface of the first base portion as viewed in a direction of the central axis. According to the above aspect, the vibration of the first support body or the second support body effectively propagates to the resilient body as compared with a configuration in which the outer wall surface of the vibration isolator member is located radially outward of the outer peripheral surface of the first base member. Therefore, the transmission of vibration between the first member and the second member can be effectively suppressed. Furthermore, compared with a configuration in which the outer wall surface of the vibration isolator is located radially outward of the outer peripheral surface of the first base portion, there is also an advantage that the amount of the material forming the resilient body can be reduced.

In an example (aspect 6) of any one of aspects 1 to 5, an outer wall surface of the vibration isolator is located radially outward of an outer peripheral surface of the first shaft portion as viewed in a direction of the central axis. In the above aspect, the vibration of the first support body or the second support body can be effectively absorbed by the resilient body, as compared with a configuration in which the outer wall surface of the vibration isolator member is located radially inward of the outer peripheral surface of the first shaft member. Therefore, the transmission of vibration between the first member and the second member can be effectively suppressed.

In an example (aspect 7) of any one of aspects 1 to 6, the second support body includes: a second base portion having a circular shape and including a second fixing surface; and a second shaft portion protruding along the central axis from the second fixing surface and inserted into the mounting hole of the second member, in which the resilient body further includes a second side wall portion covering an outer peripheral surface of the second base portion, and in which an outer wall surface of the second side wall portion includes a planar surface portion, wherein the planar surface portion comprises a plane in contact with a second rotation-restricting part for restricting rotation of the second support body about the central axis. In the above aspect, since the second base portion of the second support body has a circular shape, it is easier to reduce the manufacturing cost of the second support body, as compared with a configuration in which the planar shape of the second base portion is, for example, a polygonal shape. On the other hand, the second side wall portion covering the outer peripheral surface of the second base portion of the resilient body includes a planar surface portion which is a planar surface abutting against the second rotation-restricting part. Rotation of the second support body is restricted by contact of the second rotation-restricting part with the planar surface portion of the second side wall portion. Therefore, in the course of fixing the second support body to the second member in a state in which the second shaft portion is inserted in the attachment hole of the second member, the probability that the vibration isolator of the resilient body will be twisted due to the rotation of the first second support body can be reduced. As described above, a reduction in the vibration isolation performance caused by the torsion of the vibration isolator can be suppressed.

A vibration isolation mechanism according to one aspect of the present disclosure includes: a first member and a second member, and a vibration isolation device disposed between the first member and the second member, in which the vibration isolation device includes: a first support body fixed to the first member; a second support body fixed to the second member; and a resilient body that connects the first support body with the second support body, in which the first support body includes: a first base portion having a circular shape and including a first fixing surface; a first shaft portion protruding from the first fixing surface along a central axis and inserted into a mounting hole of the first member, in which the resilient body includes: a first side wall portion covering an outer peripheral surface of the first base portion; and a vibration isolator located between the first support body and the second support body, and in which an outer wall surface of the first side wall portion includes a planar surface portion, with the planar surface portion comprising a plane in contact with a first rotation-restricting part for restricting rotation of the first support body about the central axis.

### DESCRIPTION OF REFERENCE SIGNS

100 ... vibration isolation mechanism, 10 ... first structure, 11 ... first member, 12 ... first mounting hole, 13 ... first mounting surface, 14 ... first projection, 20 ... second structure, 21 ... second member, 22 ... second mounting hole, 23 ... second mounting surface, 24 ...

second projection, 30 ... vibration isolation device, 40 ... first support body, 41 ... first base portion, 411 ... first fixing surface, 412 ... first facing surface, 42 ... first shaft portion, 50 ... second support body, 51 ... second base portion, 511 ... second fixing surface, 512 ... second facing surface, 52 ... second shaft portion, 60 ... resilient body, 61 ... first side wall portion, 62 ... second side wall portion, 63 ... first covering part, 64 ... second covering part, 65 ... vibration isolator, P1 ... planar surface portion, Q1 ... curved surface portion, P2 ... planar surface portion, Q2 ... curved surface portion.

What is claimed is:

1. A vibration isolation device disposed between a first member and a second member, the vibration isolation device comprising:
a first support body fixed to the first member;
a second support body fixed to the second member; and
a resilient body that connects the first support body with the second support body,
wherein the first support body includes:
a first base portion having a circular shape and including a first fixing surface; and
a first shaft portion protruding from the first fixing surface along a central axis and inserted into a mounting hole of the first member,
wherein the resilient body includes:
a first side wall portion covering an outer peripheral surface of the first base portion; and
a vibration isolator located between the first support body and the second support body, and
wherein an outer wall surface of the first side wall portion includes a planar surface portion, wherein the planar surface portion comprises a plane in contact with a first rotation-restricting part for restricting rotation of the first support body about the central axis.

2. The vibration isolation device according to claim 1, wherein:
the outer wall surface of the first side wall portion further includes a curved surface portion, wherein the curved surface portion comprises a curved surface circumferentially adjacent to the planar surface portion, and
a thickness of the first side wall portion in the planar surface portion is less than a thickness of the first side wall portion in the curved surface portion.

3. The vibration isolation device according to claim 1, wherein an external shape of the first side wall portion as viewed in a direction of the central axis is a polygonal shape with arc-shaped corner portions.

4. The vibration isolation device according to claim 1, wherein an external dimension of the vibration isolator in a cross section perpendicular to the central axis is constant along the central axis.

5. The vibration isolation device according to claim 1, wherein an outer wall surface of the vibration isolator is located radially inward of an outer peripheral surface of the first base portion as viewed in a direction of the central axis.

6. The vibration isolation device according to claim 1, wherein an outer wall surface of the vibration isolator is located radially outward of an outer peripheral surface of the first shaft portion as viewed in a direction of the central axis.

7. The vibration isolation device according to claim 1,
wherein the second support body includes:
a second base portion having a circular shape and including a second fixing surface; and
a second shaft portion protruding along the central axis from the second fixing surface and inserted into the mounting hole of the second member,
wherein the resilient body further includes a second side wall portion covering an outer peripheral surface of the second base portion, and
wherein an outer wall surface of the second side wall portion includes a planar surface portion, wherein the planar surface portion comprises a plane in contact with a second rotation-restricting part for restricting rotation of the second support body about the central axis.

8. A vibration isolation mechanism comprising:
a first member;
a second member; and
a vibration isolation device disposed between the first member and the second member,
wherein the vibration isolation device includes:
a first support body fixed to the first member;
a second support body fixed to the second member; and
a resilient body that connects the first support body with the second support body,
wherein the first support body includes:
a first base portion having a circular shape and including a first fixing surface;
a first shaft portion protruding from the first fixing surface along a central axis and inserted into a mounting hole of the first member,
wherein the resilient body includes:
a first side wall portion covering an outer peripheral surface of the first base portion; and
a vibration isolator located between the first support body and the second support body, and
wherein an outer wall surface of the first side wall portion includes a planar surface portion, wherein the planar surface portion comprises a plane in contact with a first rotation-restricting part for restricting rotation of the first support body about the central axis.
